(19) United States
(12) Patent Application Publication
(10) Pub. No.: US 2018/0263842 A1
(43) Pub. Date: Sep. 20, 2018

(54) MASSAGING DEVICE HAVING STORABLE HANDLE

(71) Applicant: Paul CHEN, Vancouver (CA)

(72) Inventor: Paul CHEN, Vancouver (CA)

(21) Appl. No.: 15/460,269

(22) Filed: Mar. 16, 2017

(51) Int. Cl. A61H 15/00

(52) U.S. Cl. CPC A61H 15/0092; A61H 2201/0161; A61H 2201/1253

(57) ABSTRACT

A massaging device includes a sleeve engaged onto a housing for being grasped by a user, and two handle members slidably engaged into the housing and extendible out of the housing to an outwardly extended working position and engageable in the housing to an inwardly folded structure, a tubular member is engaged in the housing, the housing includes two tongues extended into the chamber of the housing for engaging with the handle members and for anchoring the handle members to the housings at the inwardly folded structure. The handle members each include a lock slot for engaging with the tongues and for anchoring the handle members to the housing at the inwardly folded structure.

### BACKGROUND OF THE INVENTION

### 1. Field of the Invention

The present invention relates to a massaging device, and more particularly to a massaging device including a foldable or storable handle device receivable or engageable within an outer protective cover or sleeve for allowing the massaging device to be folded or stored in a compact folding or storing structure or configuration and for allowing the massaging device to be easily actuated or operated by the user.

### 2. Description of the Prior Art

Typical massaging devices comprise a relatively harder or stronger inner housing, and a relatively softer or resilient outer layer for selectively contacting or engaging with the users and for massaging purposes.

For example, U.S. Pat. No. 4,807,603 to Yasui discloses one of the typical massaging devices also comprising a relatively harder or stronger inner housing having a cylindrical shape or contour or structure, and a relatively softer or resilient outer layer for selectively contacting or engaging with the users and for massaging purposes.

U.S. Pat. No. 8,888,808 to Park discloses another typical massaging device comprising a planar base member having a number of projections or protrusions extended outwardly therefrom for frictionally contacting or engaging with the users and for massaging purposes.

However, the typical massaging devices include a solid structure or configuration that may not be folded or stored in a compact folding or storing structure or configuration and that may not be easily actuated or operated by the user.

The present invention has arisen to mitigate and/or obviate the afore-described disadvantages of the conventional massaging devices.

### SUMMARY OF THE INVENTION

The primary objective of the present invention is to provide a massaging device including a foldable or storable handle device receivable or engageable within an outer protective cover or sleeve for allowing the massaging device to be folded or stored in a compact folding or storing structure or configuration and for allowing the massaging device to be easily actuated or operated by the user.

In accordance with one aspect of the invention, there is provided a massaging device comprising a housing including a chamber formed therein, and including two end portions, a sleeve engaged onto the housing for being grasped by a user, and two handle members slidably received and engaged into the chamber at the end portions of the housing, the handle members being extendible out of the housing to an outwardly extended working position selectively, and the handle members being selectively receivable and engageable in the chamber of the housing to an inwardly folded structure, a tubular member is received and engaged in the chamber of the housing and attached to the tubular member, the housing includes two tongues extended into the chamber of the housing and adapted to engage with the handle members respectively for anchoring and retaining the handle members to the housings at the inwardly folded structure.

The housing includes a peripheral bulge extended radially and inwardly into the chamber of the housing for forming an opening in the peripheral bulge of the housing and for receiving and engaging with the tubular member. The tubular member includes at least one flange extended therefrom for engaging with the peripheral bulge of the housing for anchoring and retaining the tubular member to the housing and for preventing the tubular member from being disengaged from the housing.

The tubular member includes a bore formed therein, and two rods are attached to the handle members respectively and slidably received and engaged in the bore of the tubular member. The rods each include a stud extended therefrom, and the handle members each include a cavity formed therein for engaging with the stud of the rod and for anchoring and positioning the handle member to the tubular member. The handle members each include an extension extended therein, and the cavity is formed in the extension for receiving and engaging with the stud of the rod.

A spring biasing member may be engaged with the rods of the handle members for biasing and moving the handle members out of the housing to the outwardly extended working position selectively. The handle members each include a lock slot formed therein for selectively engaging with the tongues of the housing and for anchoring and positioning the handle members in the chamber of the housing at the inwardly folded structure.

The handle members each include a peripheral swelling extended radially and outwardly therefrom, and the lock slots are formed in the peripheral swellings of the handle members respectively. The housing includes two ears extended and engaged into the chamber of the housing for engaging with the peripheral swellings of the handle members respectively and for preventing the handle members from being disengaged from the housing. The housing includes two levers, and the ears are extended from the levers respectively and extended and engaged into the chamber of the housing.

The housing includes two passages formed therein, and the ears are engaged through the passages and into the chamber of the housing. The tongues are extended from the levers respectively and extended and engaged into the chamber of the housing for engaging with the handle members respectively. The housing includes two recesses formed therein, and the tongues are engaged through the recesses and into the chamber of the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a massaging device in accordance with the present invention;

FIG. 2 is a perspective view of the massaging device;

FIG. 3 is another perspective view of the massaging device similar to FIG. 2, in which the handle device is folded or stored in a compact folding or storing structure or configuration; and

FIGS. 4, 5 are cross sectional views of the massaging device, taken along lines 4-4, and 5-5 of FIGS. 2 and 3 respectively.

### DETAILED DESCRIPTION OF THE PREFERRED EMBODIMENT

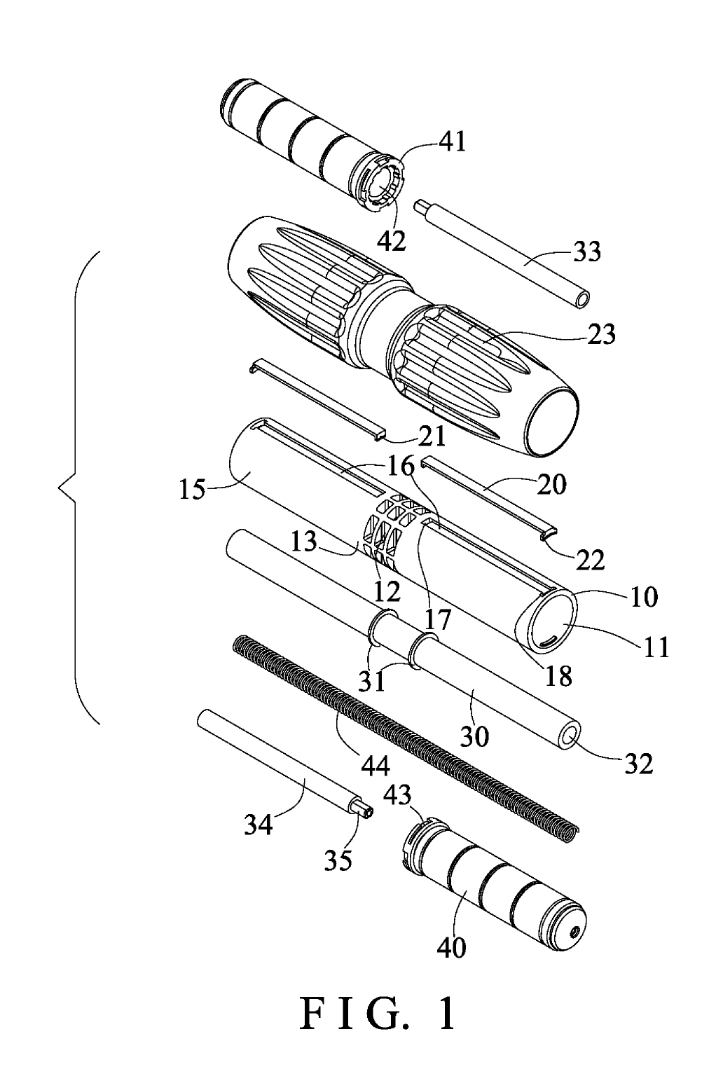

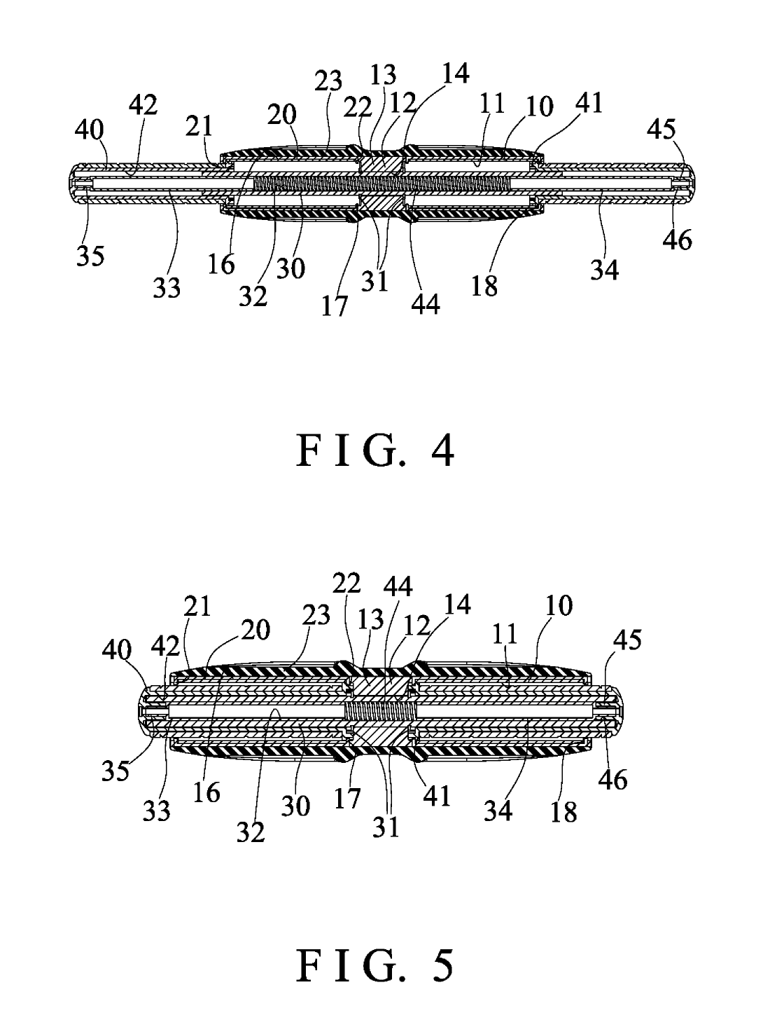

Referring to the drawings, and initially to FIG. 1, a massaging device in accordance with the present invention comprises a cylindrical barrel or housing 10 including a hollow structure or configuration having a compartment or bore or chamber 11 formed therein, and including a peripheral swelling or bulge 12 extended radially and inwardly into the chamber 11 of the housing 10 (FIGS. 4, 5) for forming or defining a bore or opening 14 in the peripheral bulge 12 of the housing 10. The housing 10 includes one or more (such as two) end portions 15 each having one or more (such as two) elongated or longitudinal recesses 16 formed therein, and the longitudinal recesses 16 at each of the end portions 15 of the housing 10 are arranged or located opposite to each other, and it is preferable, but not necessary that the longitudinal recesses 16 at the end portions 15 of the housing 10 are aligned or in line with each other.

A number of bars or levers 20 are further be provided and attached or mounted or engaged into the longitudinal recesses 16 of the housing 10 respectively. The housing 10 further includes an aperture 17 and a passage 18 formed in the housing 10, such as formed in the end portions of each of the longitudinal recesses 16 of the housing 10 and communicating with the longitudinal recess 16 and the chamber 11 of the housing 10. The levers 20 each include a stud or tongue 21 and a flap or ear 22 extended therefrom, and engaged or extended through the aperture 17 and the passage 18 and into the chamber 11 of the housing 10. An outer cover or sleeve 23 is attached or mounted or secured or engaged onto the housing 10 and made of a relatively softer or resilient material, such as plastic, synthetic materials, rubber or the like, and arranged for allowing the user to solidly and stably grasp or hold the sleeve 23 and the housing 10.

As best shown in FIGS. 4 and 5, the tongues 21 and the ears 22 of the levers 20 may be positioned and retained in the chamber 11 of the housing 10 by the sleeve 23, such as by the resilient or spring biasing force of the sleeve 23. Alternatively or optionally, the tongues 21 and the ears 22 of the levers 20 may be formed integral with the housing 10 and/or may be directly extended from the housing 10 and into the chamber 11 of the housing 10. A rod or tubular member 30 is received or engaged in the chamber 11 of the housing 10 and engaged or extended through the opening 14 that is formed or provided in the peripheral bulge 12 of the housing 10. The tubular member 30 includes one or more (such as two) peripheral rib or flange 31 extended radially and outwardly therefrom (FIGS. 1, 4-5) for contacting or engaging with the housing 10, such as the peripheral bulge 12 of the housing 10 for solidly and stably anchoring or positioning or retaining the tubular member 30 to the housing 10 and for preventing the tubular member 30 from being disengaged or separated from the housing 10.

The tubular member 30 includes an opening or bore 32 formed therein for slidably receiving or engaging with one or more (such as two) poles or rods 33, 34 therein, the rods 33, 34 may be slidably moved along the bore 32 of the tubular member 30, and the rods 33, 34 each include a peg or stud 35 extended therefrom and extendible or locateable within the bore 32 of the tubular member 30 (FIG. 5). One or more (such as two) handle members 40 are slidably receivable and extendible or engageable into the chamber 11 at the end portions 15 of the housing 10. The handle members 40 each include a peripheral bulge or swelling 41 extended radially and outwardly therefrom, such as extended from the inner end portion thereof, and the ears 22 of the levers 20 may be contacted or engaged with the peripheral swellings 41 of the handle members 40 for preventing the handle members 40 from being disengaged or separated from the housing 10.

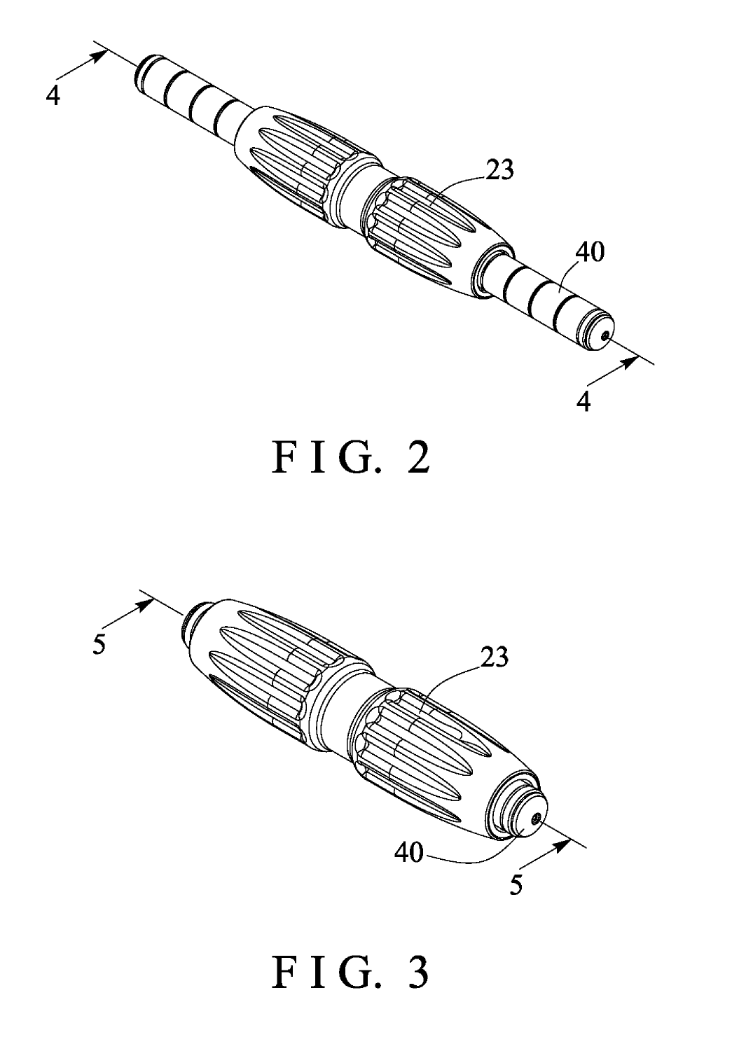

The handle members 40 each include an inner chamber or bore or compartment 42 formed therein for slidably receiving or engaging with the tubular member 30 and for allowing the handle members 40 to be moved or engaged into the chamber 11 of the housing 10 selectively. The handle members 40 each further include one or more lock notches or slots 43, such as L-shaped lock slots 43 formed therein (FIG. 1) for selectively engaging with the tongues 21 of the levers 20 or of the housing 10 and for selectively anchoring or positioning or retaining or locking the handle members 40 in the chamber 11 of the housing 10 (FIGS. 3, 5). A spring biasing member 44 may further be provided and disposed or engaged within the bore 32 of the tubular member 30 and disposed or engaged between the rods 33, 34 for biasing and forcing or moving the rods 33, 34 and the handle members 40 out of the housing 10 (FIGS. 2, 4) selectively.

For example, when the tongues 21 of the levers 20 or of the housing 10 are disengaged or separated from the lock slots 43 of the handle members 40, the spring biasing member 44 may bias and force or move the rods 33, 34 and the handle members 40 out of the housing 10 (FIGS. 2, 4) selectively. The tongues 21 of the levers 20 or of the housing 10 may be engaged with the lock slots 43 of the handle members 40 for locking the handle members 40 in the chamber 11 of the housing 10 when the handle members 40 are pivoted or rotated relative to the housing 10 and/or the tubular member 30. It is preferable, but not necessary that the handle members 40 each include an extension 45 extended therein and having a cavity 46 formed therein (FIGS. 4, 5) for selectively receiving or engaging with the studs 35 of the rods 33, 34 and/or of the handle members 40 with such as a force-fitted engagement, welders or adhesive materials or the like, and for further solidly and stably anchoring or positioning or retaining or locking the rods 33, 34 in the handle members 40 respectively.

In operation, as shown in FIGS. 2 and 4, when the lock slots 43 of the handle members 40 are disengaged or separated from the tongues 21 of the levers 20 or of the housing 10, the spring biasing member 44 may bias and force or move the handle members 40 out of the housing 10 to the outwardly extended working position, and the user may grasp or hold the handle members 40 to actuate or operate the massaging device in accordance with the present invention, and to contact or engage the outer cover or sleeve 23 that is made of a relatively softer or resilient material, such as plastic, synthetic materials, rubber or the like, with the user in order to conduct or actuate various massaging operations. As shown in FIGS. 3 and 5, the handle members 40 may be selectively forced and moved or engaged into the chamber 11 of the housing 10 at the compact folding or storing structure or configuration.

The handle members 40 may be pivoted or rotated relative to the housing 10 and/or the tubular member 30 in order to engage the tongues 21 of the levers 20 or of the housing 10 into the lock slots 43 of the handle members 40, and so as to detachably attach or secure or anchor and lock the handle members 40 to the housing 10 and for preventing the handle members 40 from being disengaged or separated from the housing 10, and the handle members 40 may be solidly and stably anchored or positioned or retained between the tubular member 30 and the housing 10. The studs 35 of the rods 33, 34 and/or of the tubular member 30 may be engaged with the cavities 46 of the extensions 45 of the handle members 40 for solidly and stably anchoring or positioning or retaining or locking the rods 33, 34 in the handle members 40. The handle members 40 may be biased and forced to move out of the housing 10 to the outwardly extended working position with the spring biasing member 44 again when the handle members 40 are pivoted or rotated relative to the housing 10 and/or the tubular member 30 in order to disengage the tongues 21 of the levers 20 or of the housing 10 from the lock slots 43 of the handle members 40.

Accordingly, the massaging device in accordance with the present invention includes a foldable or storable handle device receivable or engageable within an outer protective cover or sleeve for allowing the massaging device to be folded or stored in a compact folding or storing structure or configuration and for allowing the massaging device to be easily actuated or operated by the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A massaging device comprising:
a housing including a chamber formed therein, and including two end portions;
a sleeve engaged onto the housing for being grasped by a user; and
two handle members slidably received and engaged into the chamber at the end portions of the housing, the handle members being extendible out of the housing to an outwardly extended working position selectively, and the handle members being selectively receivable and engageable in the chamber of the housing to an inwardly folded structure; wherein
a tubular member is received and engaged in the chamber of the housing and attached to said tubular member, the housing includes two tongues extended into the chamber of the housing and adapted to engage with the handle members respectively for anchoring and retaining the handle members to the housings at the inwardly folded structure.

2. The massaging device as claimed in claim 1, wherein said housing includes a peripheral bulge extended radially and inwardly into the chamber of the housing for forming an opening in the peripheral bulge of the housing and for receiving and engaging with the tubular member.

3. The massaging device as claimed in claim 2, wherein said tubular member includes at least one flange extended therefrom for engaging with the peripheral bulge of the housing for anchoring and retaining the tubular member to the housing and for preventing the tubular member from being disengaged from the housing.

4. The massaging device as claimed in claim 1, wherein said tubular member includes a bore formed therein, and two rods attached to said handle members respectively and slidably received and engaged in the bore of the tubular member.

5. The massaging device as claimed in claim 4, wherein said rods each include a stud extended therefrom, and the handle members each include a cavity formed therein for engaging with the stud of the rod and for anchoring and positioning the handle member to the tubular member.

6. The massaging device as claimed in claim 5, wherein said handle members each include an extension extended therein, and said cavity is formed in the extension for receiving and engaging with the stud of the rod.

7. The massaging device as claimed in claim 1, wherein a spring biasing member is engaged with the rods for biasing and moving the handle members out of the housing to the outwardly extended working position selectively.

8. The massaging device as claimed in claim 1, wherein said handle members each include a lock slot formed therein for selectively engaging with the tongues of the housing and for anchoring and positioning the handle members in the chamber of the housing at the inwardly folded structure.

9. The massaging device as claimed in claim 8, wherein said handle members each include a peripheral swelling extended radially and outwardly therefrom, and the lock slots are formed in the peripheral swellings of said handle members respectively.

10. The massaging device as claimed in claim 9, wherein said housing includes two ears extended and engaged into the chamber of the housing for engaging with the peripheral swellings of the handle members respectively and for preventing the handle members from being disengaged from the housing.

11. The massaging device as claimed in claim 10, wherein said housing includes two levers, and said ears are extended from the levers respectively and extended and engaged into the chamber of the housing.

12. The massaging device as claimed in claim 11, wherein said housing includes two passages formed therein, and said ears are engaged through the passages and into the chamber of the housing.

13. The massaging device as claimed in claim 11, wherein said tongues are extended from the levers respectively and extended and engaged into the chamber of the housing for engaging with the handle members respectively.

14. The massaging device as claimed in claim 13, wherein said housing includes two recesses formed therein, and said tongues are engaged through the recesses and into the chamber of the housing.
